(19) United States
(12) Patent Application Publication
(10) Pub. No.: US 2015/0321330 A1
(43) Pub. Date: Nov. 12, 2015

(54) HANDLED RATCHETING TOOL WITH A FLIP OUT HANDLE

(71) Applicant: WAGIC, INC, San Jose, CA (US)

(72) Inventors: Ronald L. Johnson, San Jose, CA (US); Yugen Patrick Lockhart, Palo Alto, CA (US)

(21) Appl. No.: 14/804,527

(22) Filed: Jul. 21, 2015

Related U.S. Application Data
(63) Continuation of application No. 12/573,709, filed on Oct. 5, 2009, now Pat. No. 9,120,208.

(51) Int. Cl. B25G 1/00; B25G 1/06; B25B 15/04

(52) U.S. Cl. CPC B25G 1/005; B25B 15/04; B25G 1/063

(57) ABSTRACT

A handled ratcheting tool is able to be used in a standard, L handle or T handle orientation. The handled ratcheting tool includes a handle, a stem, a ratcheting mechanism and multiple tools. Multiple tools are coupled to the ratcheting mechanism which are able to form the L and T configurations depending on which tools are positioned in an open position and which are in a closed position.

### FIELD OF THE INVENTION

The present invention relates to hand tools. More specifically, the present invention relates to a handled ratcheting tool which is able to be configured in several different handle configurations.

### BACKGROUND OF THE INVENTION

T handle tools have a T-shaped body, including a long leg member and a short handle member. T handles usually have hexagonal-shaped tips for use with screws and other objects designed to accept a hexagonal tip. Once inserted, rotational pressure is applied to the hexagonal wrench in order to tighten or loosen the screw. The leg member and handle of the hexagonal wrench are designed to be in the shape of the letter “T” so that a user is able to grasp the handle with his hand(s) more comfortably.

T handle tools are manufactured and distributed in multiple English and metric sizes in order to facilitate their use with screw heads of multiple sizes. Such tools are usually sold in a set which includes tools of multiple sizes but are also distributed individually.

When using a T handle tool, a user will insert a leg end of the T handle tool onto the head of a workpiece such as a hexagonal screw, and will then exert rotational pressure using the handle on the handle end of the tool in order to tighten or loosen the screw.

While the T handle tool is very helpful, there are instances due to space constrictions, that a T handle orientation is not usable and a modified orientation is needed for a hard to reach screw.

### SUMMARY OF THE INVENTION

A handled ratcheting tool is able to be used in a standard, L handle or T handle orientation. The handled ratcheting tool includes a handle, a stem, a ratcheting mechanism and multiple tools. Multiple arms are coupled to the ratcheting mechanism which are able to form the L and T configurations depending on which arms are positioned in an open position and which are in a closed position.

In one aspect, a device comprises a handle element including a stem element, a tool coupled to the stem element, a ratcheting element coupled to the handle element and a plurality of arms coupled to the ratcheting element, the plurality of arms configurable in a screwdriver mode, a T-handle mode and an L-handle mode. The plurality of arms are configured to be positioned against the handle element when configured in a closed position. The tool is detachably coupled to the stem element. The ratcheting element includes a switch for toggling a ratcheting direction. The device further comprises a hinge configured for coupling each of the plurality of arms to the ratcheting element. The screwdriver mode includes the plurality of arms positioned against the handle element in a closed position. The T-handle mode includes the plurality of arms positioned approximately perpendicular to the handle element in an open position. The L-handle mode includes one of the plurality of arms positioned approximately perpendicular to the handle element in an open position. The tool and the plurality of arms are configured to be utilized with a screw or a bolt. The screw or the bolt has a slotted, a Phillips, a hexagonal or a star head. The device comprises rubber, plastic, polymers, metal or a combination thereof.

In another aspect, a method of utilizing a device comprises configuring the device into any of three modes, the modes including a screwdriver mode, a T-handle mode and an L-handle mode and using the device in the configured mode. The device comprises a handle element including a stem element, a tool coupled to the stem element, a ratcheting element coupled to the handle element and a plurality of arms coupled to the ratcheting element, the plurality of arms configurable in the screwdriver mode, the T-handle mode and the L-handle mode. Configuring the device into the screwdriver mode includes orienting the plurality of arms against the handle element. Configuring the device into the T-handle mode includes orienting the plurality of arms to an open position approximately perpendicular to the handle element. Configuring the device into the L-handle mode includes orienting one of the plurality of arms to an open position approximately perpendicular to the handle element. The plurality of arms are configured to be positioned against the handle element when configured in a closed position. The tool is detachably coupled to the stem element. The ratcheting element includes a switch for toggling a ratcheting direction. The device further comprises a hinge for each of the plurality of arms, the hinge for coupling each of the plurality of arms to the ratcheting element. The tool and the plurality of arms are configured to be utilized with a screw or a bolt. The screw or the bolt has a slotted, a Phillips, a hexagonal or a star head. The device comprises rubber, plastic, polymers, metal or a combination thereof.

In another aspect, a method of manufacturing a device comprises forming a set of components including a handle element, a stem element, a ratcheting mechanism, a first arm, a second arm and a tool and coupling the set of components including coupling the ratcheting mechanism to the handle element, coupling the stem element to the ratchet mechanism, coupling the first arm to the ratcheting mechanism, coupling the second arm to the ratcheting mechanism and coupling the tool to the stem element. The handle element is formed so the first and second arms are able to be positioned against the handle element. The first arm, the second arm and the tool are formed as screwdrivers, hex/allen wrenches, star wrenches or a combination thereof. The first arm and the second arm are coupled to the ratcheting mechanism at hinges to enable rotation between a closed position and an open position. The tool is detachably coupled to the stem element. The device is configurable in a screwdriver mode, a T-handle mode and an L-handle mode. The ratcheting element includes a switch for toggling a ratcheting direction. The tool is configured to be utilized with a screw or a bolt. The screw or the bolt has a slotted, a Phillips, a hexagonal or a star head. The device comprises rubber, plastic, polymers, metal or a combination thereof.

In yet another aspect, a device comprises a handle element including a stem element, a tool detachably coupled to the stem element, a ratcheting element coupled to the handle element and a plurality of tools coupled to the ratcheting element, each of the plurality of tools coupled at a hinge, the plurality of tools configurable in a screwdriver mode wherein the plurality of tools are positioned against the handle element in a closed position, a T-handle mode wherein the plurality of tools are positioned approximately perpendicular to the handle element in an open position and an L-handle mode wherein one of the plurality of tools is positioned approximately perpendicular to the handle element in the open position.

### BRIEF DESCRIPTION OF THE DRAWINGS

FIG. 1 illustrates a side view of a handled ratcheting tool in a screwdriver mode in accordance with an embodiment.

FIG. 2 illustrates a side view of a handled ratcheting tool in a T-handle mode in accordance with an embodiment.

FIG. 3 illustrates a side view of a handled ratcheting tool in an L-handle mode in accordance with an embodiment.

FIG. 4 illustrates a perspective view of a handled ratcheting tool in a T-handle mode in accordance with an embodiment.

FIG. 5 illustrates a flowchart of methods of configuring a handled ratcheting tool in accordance with an embodiment.

FIG. 6 illustrates a flowchart of a method of manufacturing a handled ratcheting tool in accordance with an embodiment.

FIG. 7 illustrates a side view of a handled ratcheting tool in a screwdriver mode in accordance with an embodiment.

FIG. 8 illustrates a perspective view of a handled ratcheting tool in a T-handle mode in accordance with an embodiment.

### DETAILED DESCRIPTION

A handled ratcheting tool with flip out handle enables a user to use the handle in a standard configuration, an L handle configuration and also a T handle configuration providing a very versatile tool.

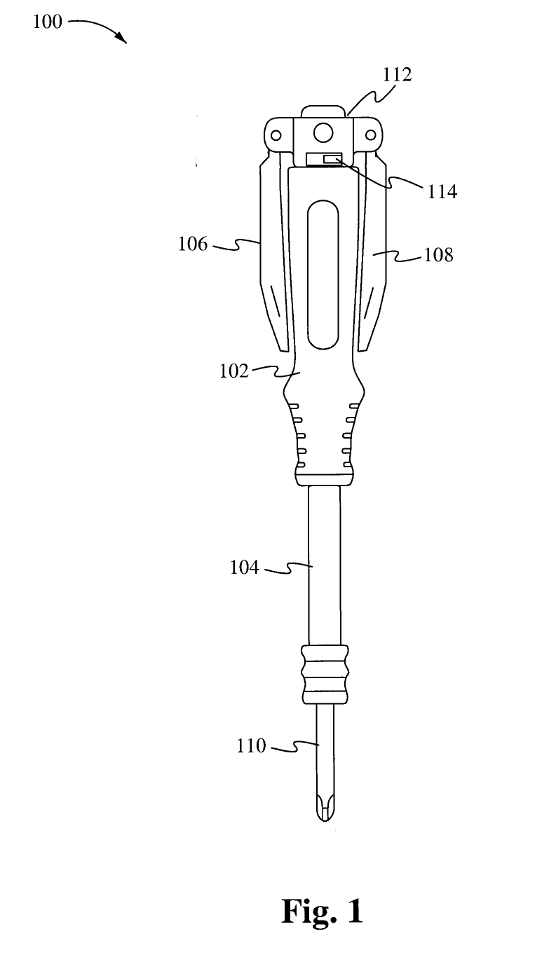

FIG. 1 illustrates a side view of a handled ratcheting tool 100 in a screwdriver mode. Although referred to as screwdriver mode, screwdriver mode is able to be used with any device (screw, bolt and others) and also is able to be used with any type of driving device (hex, slotted, star, Phillips, sockets and others). The handled ratcheting tool 100 includes a handle 102, a stem 104, a first arm 106, a second arm 108, a tool 110, a ratcheting mechanism 112 and a switch 114.

The handle 102 is configured for a user to be able to grip the handle 102. In some embodiments, the handle 102 is configured for the first arm 106 and the second arm 108 to fit against and/or within the handle 102. The stem 104 is coupled to the handle 102. In some embodiments, the stem 104 includes the tool 110 affixed at the end of the stem 104. In some embodiments, the stem 104 is configured to receive removable tools 110 which are able to be inserted and removed as desired. The first arm 106 and the second arm 108 are coupled to the end of the handle 102. The first arm 106 and the second arm 108 are coupled on opposite sides of the handle 102, each by a hinge or other mechanism that permits rotation. The first arm 106 and the second arm 108 are configured to be able to rotate to a T-handle configuration or an L-handle configuration. The ratcheting mechanism 112 is included at the end of the handle 102 as well. The ratcheting mechanism 112 allows the handle 102 to be turned similar to any ratchet device when the handled ratcheting tool 100 is configured in the T-handle configuration. In some embodiments, the ratcheting mechanism is able to be used in configurations other than the T-handle configuration. The ratcheting mechanism 112 includes a switch 114 or other feature which enables the rotation of the ratcheting mechanism 112 to be toggled between forward, reverse, and, in some embodiments, a “lock” mode for use as a direct drive screwdriver with no ratcheting.

When the handled ratcheting tool 100 is in the screwdriver mode, the handled ratcheting tool 100 is used in the same manner as a screwdriver. The first arm 106 and the second arm 108 are configured in the closed position against and/or within the handle 102, so that the user is able to place his/her hand around the handle 102 and the first arm 106 and the second arm 108. The user is then able to turn the handled ratcheting tool 100 in the same manner as a screwdriver.

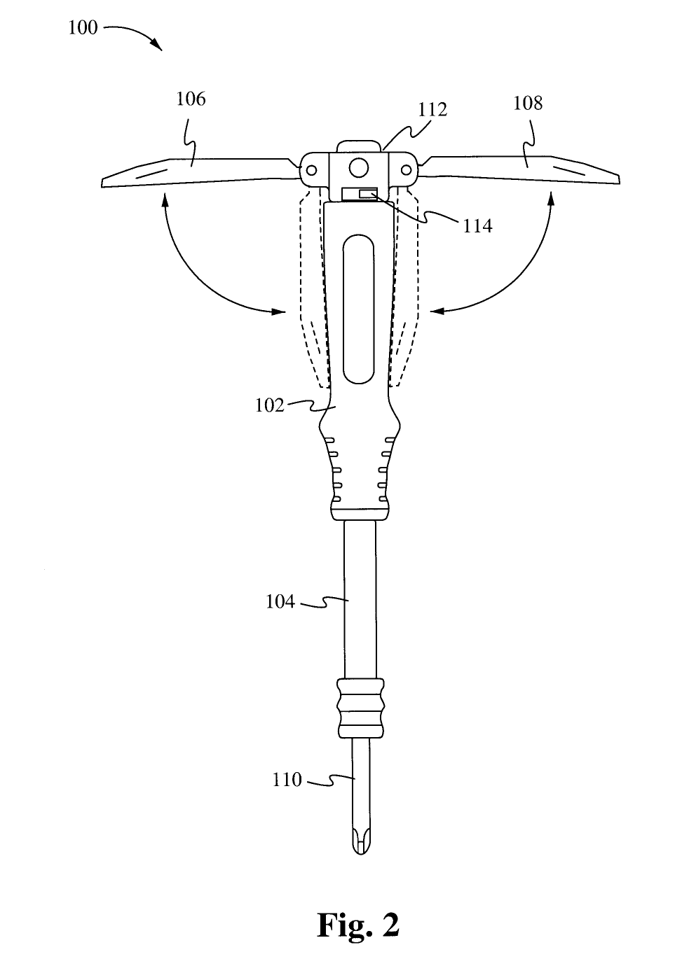

FIG. 2 illustrates a side view of a handled ratcheting tool 100 in a T-handle mode in accordance with an embodiment. When the first arm 106 and the second arm 108 are configured perpendicular to the handle 102 (also referred to as the open position), the handled ratcheting tool 100 is configured in the T-handle mode.

When the handled ratcheting tool 100 is in the T-handle mode, the handled ratcheting tool 100 is used in the same manner as a T-handle tool. A user is able to grasp the handled ratcheting tool 100 in a manner that the first arm 106 and the second arm 108 are able to provide additional torque when turning the handled ratcheting tool 100. The T-handle mode allows the user to install or remove an object such as a screw when the screwdriver mode provides insufficient leverage.

The ratcheting mechanism 112 is included at the end of the handle 102 to allow the handle 102 to be turned similar to any ratchet device when the handled ratcheting tool 100 is configured in the T-handle configuration. The ratcheting mechanism 112 includes a switch 114 which enables the rotation of the ratcheting mechanism 112 to be toggled for either installing or removing an object such as a screw.

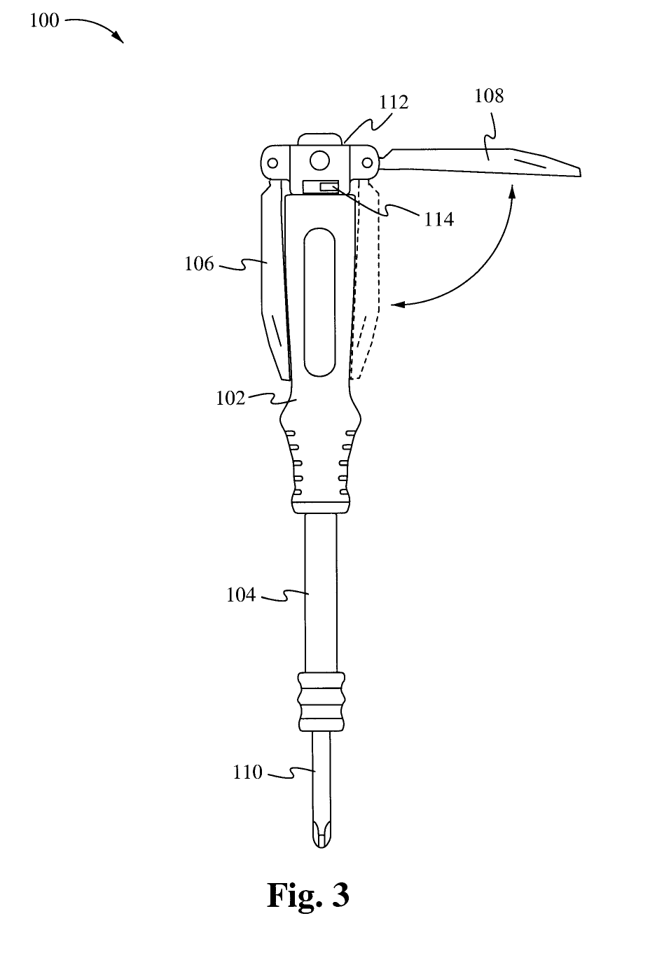

FIG. 3 illustrates a side view of a handled ratcheting tool in an L-handle mode in accordance with an embodiment. The L-handle mode is when either the first arm 106 or the second arm 108 is configured perpendicular to the handle 102 (open position), and the other of the first arm 106 or the second arm 108 is configured against and/or within the handle 102 (closed position).

When the handled ratcheting tool 100 is in the L-handle mode, the handled ratcheting tool 100 is used in the same manner as an L-handle tool. A user is able to grasp the handled ratcheting tool 100 at the handle 102 with the arm such as the second arm 108 facing the object to be manipulated (such as tightened or loosened). For additional torque, the user is able to grasp the handled ratcheting tool 100 at the stem 104 or even at the tool 110. The L-handle mode allows the user to install or remove an object such as a screw when the screwdriver mode is insufficient due to leverage or when there is not sufficient room to grasp the T-handle mode.

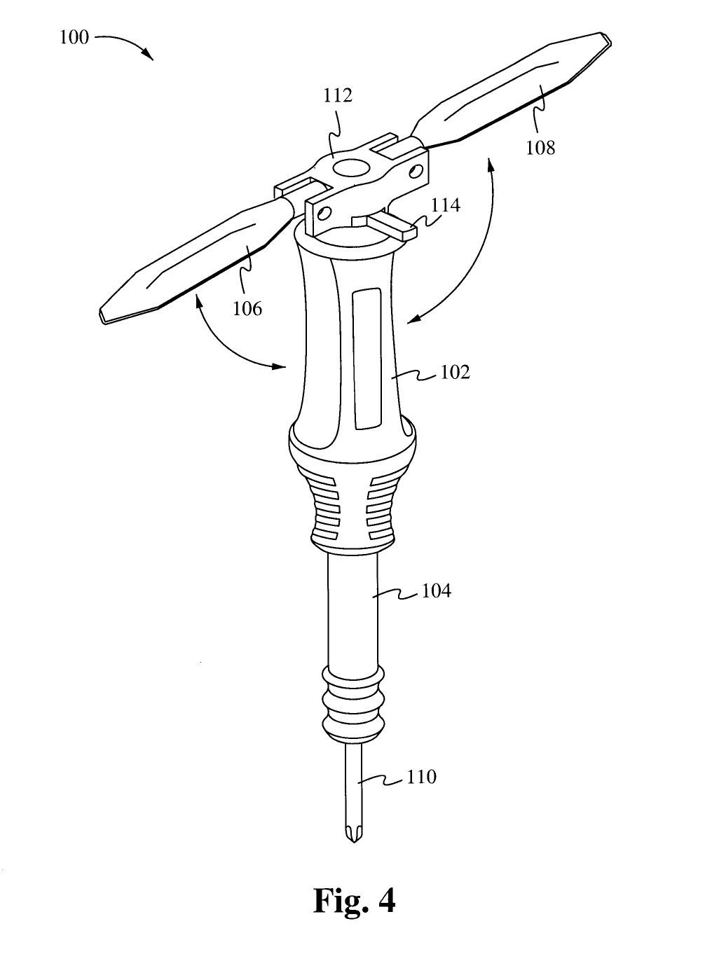

FIG. 4 illustrates a perspective view of a handled ratcheting tool 100 in a T-handle mode in accordance with an embodiment. As described above, the handled ratcheting tool 100 is put into the T-handle mode by orienting, such as rotating, the first arm 106 and the second arm 108 to an open position where each arm is perpendicular to the handle 102.

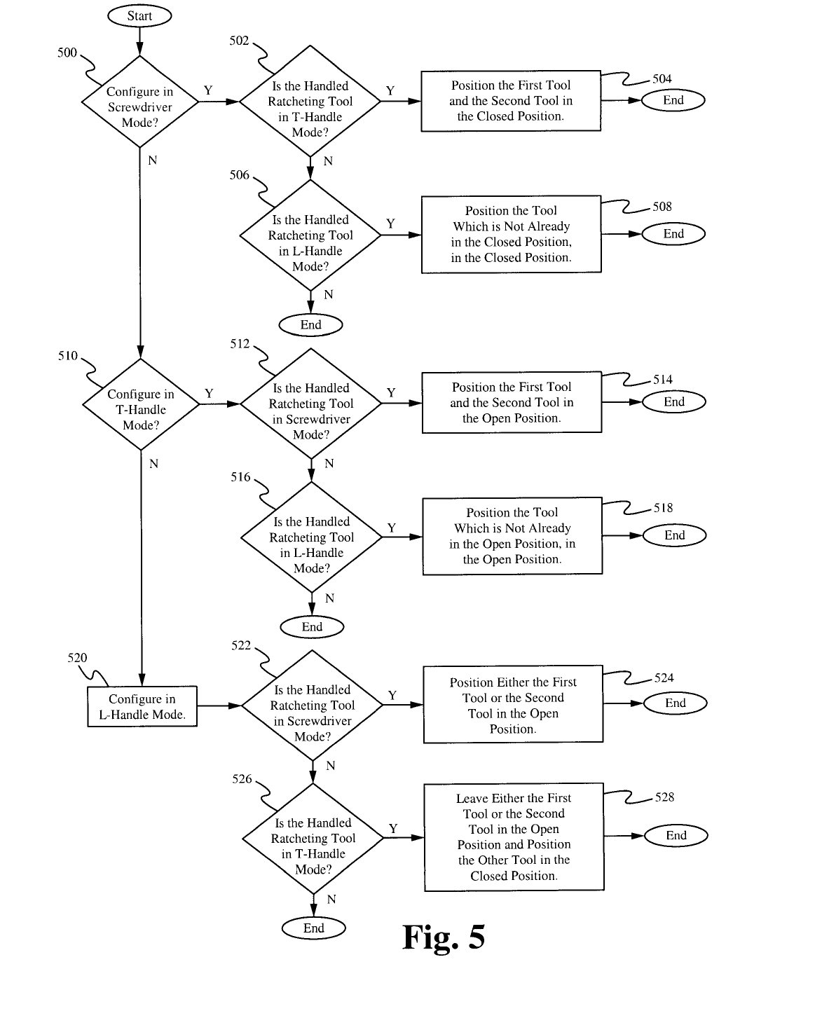

FIG. 5 illustrates a flowchart of methods of configuring a handled ratcheting tool in accordance with an embodiment. In the step 500, it is determined if a user wants to configure the handled ratcheting tool into the screwdriver mode. If the user wants to configure the handled ratcheting tool into the screwdriver mode, then it is determined if the handled ratcheting tool is in the T-handle mode, in the step 502. If the handled ratcheting tool is in the T-handle mode, then the first arm and the second arm are moved/rotated/positioned into the closed position, in the step 504. If it is determined that the handled ratcheting tool is in the L-handled mode, in the step 506, then the arm (either the first or second) which is not already in the closed position is moved/rotated/positioned in the closed position, in the step 508. In the step 510, it is determined if a user wants to configure the handled ratcheting tool into the T-handle mode. If the user wants to configure the handled ratcheting tool into the T-handle mode, then it is determined if the handled ratcheting tool is in the screwdriver mode, in the step 512. If the handled ratcheting tool is in the screwdriver mode, then the first arm and the second arm are moved/rotated/positioned into the open position, in the step 514. If the handled ratcheting tool is in the L-handle mode in the step 516, then the arm (either the first or the second arm) which is not already in the open position is moved/rotated/positioned in the open position, in the step 518. In the step 520, the user wants to configure the handled ratcheting tool into the L-handle mode. In the step 522, it is determined if the handled ratcheting tool is in the screwdriver mode. If the handled ratcheting tool is in the screwdriver mode, then either the first arm or the second arm is moved/rotated/positioned in the open position, in the step 524. If the handled ratcheting tool is in the T-handle mode, in the step 526, then either the first arm or the second arm is left in the open position and the other arm is moved/rotated/positioned in the closed position, in the step 528. Once the handled ratcheting tool is configured into the desired mode or configuration, the user uses the tool by appropriately grasping the correct portion of the tool for use. For example, in the screwdriver mode, the user grasps the handle portion including the closed first arm and second arm. In the T-handle mode, the user places his/her fingers around the first arm and the second arm. When using the T-handle mode, the user is able to utilize the ratcheting mechanism which includes a switch to toggle the direction of the ratcheting mechanism. In the L-handle mode, the user grasps the tool at either the handle, the stem or the tool.

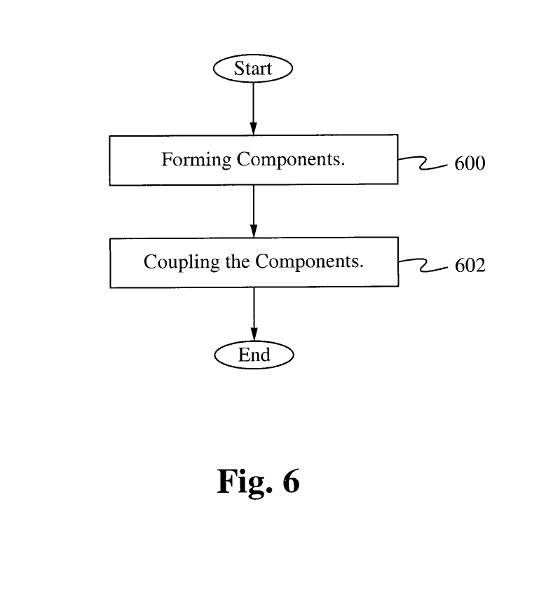

FIG. 6 illustrates a flowchart of a method of manufacturing a handled ratcheting tool in accordance with an embodiment. In the step 600, components are formed. In some embodiments, the components include a handle, a stem, a ratcheting mechanism and multiple arms and or tool(s). In some embodiments, the handle and ratcheting mechanism are formed as one piece or as two pieces. The handle is formed so that a user is able to grip the handle easily and also so the first and second arms are able to fit against and/or within the handle. The arms are formed depending on the desired tool implementation. In some embodiments, the arms are able to be formed as screwdrivers, hex/allen wrenches, star wrenches or other tools. In the step 602, the components are coupled together. Coupling the components includes coupling the ratcheting mechanism to the handle, coupling the stem to the ratcheting mechanism, coupling the first arm to the ratcheting mechanism, coupling the second arm to the ratcheting mechanism and in some embodiments, detachably coupling the tool to the stem. The first arm and the second arm are coupled to the ratcheting mechanism at hinges so that they are able to orient/move/rotate between a closed position and an open position.

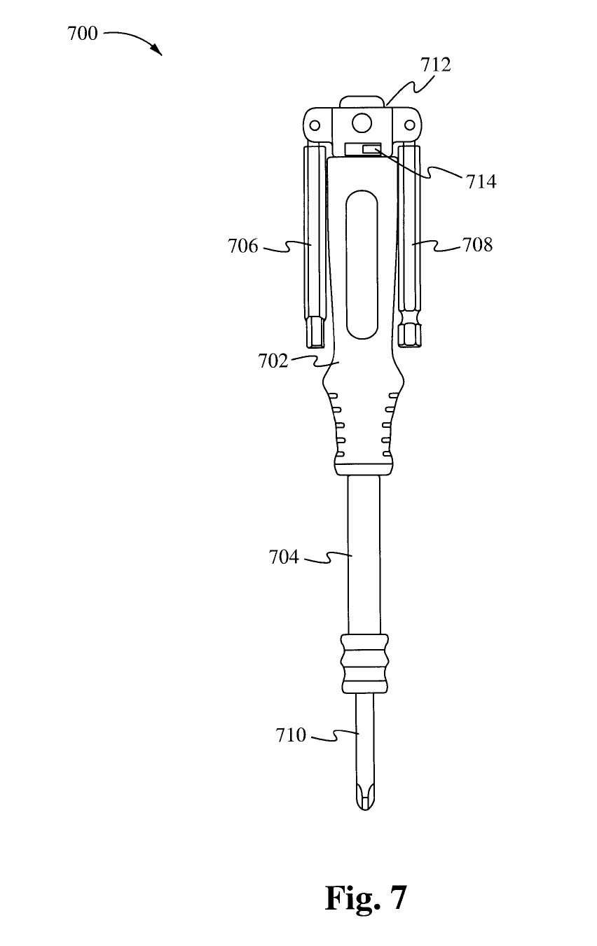

FIG. 7 illustrates a side view of a handled ratcheting tool 700 in a screwdriver mode. Although referred to as screwdriver mode, screwdriver mode is able to be used with any device (screw, bolt and others) and also is able to be used with any type of driving device (hex, slotted, star, Phillips, sockets and others). The handled ratcheting tool 700 includes a handle 702, a stem 704, a first tool 706, a second tool 708, a third tool 710, a ratcheting mechanism 712 and a switch 714.

The handle 702 is configured for a user to be able to grip the handle 702. In some embodiments, the handle 702 is configured for the first tool 706 and the second tool 708 to fit against and/or within the handle 702. The stem 704 is coupled to the handle 702. In some embodiments, the stem 704 includes the third tool 710 affixed at the end of the stem 704. In some embodiments, the stem 704 is configured to receive removable third tools 710 which are able to be inserted and removed as desired. The first arm 706 and the second arm 708 are coupled to the end of the handle 702. The first arm 706 and the second arm 708 are coupled on opposite sides of the handle 702, each by a hinge or other mechanism that permits rotation. The first arm 706 and the second arm 708 are configured to be able to rotate to a T-handle configuration or an L-handle configuration. The ratcheting mechanism 712 is included at the end of the handle 702 as well. The ratcheting mechanism 712 allows the handle 702 to be turned similar to any ratchet device when the handled ratcheting tool 700 is configured in the T-handle configuration. In some embodiments, the ratcheting mechanism is able to be used in configurations other than the T-handle configuration. The ratcheting mechanism 712 includes a switch 714 which enables the rotation of the ratcheting mechanism 712 to be toggled.

When the handled ratcheting tool 700 is in the screwdriver mode, the handled ratcheting tool 700 is used in the same manner as a screwdriver. The first tool 706 and the second tool 708 are configured in the closed position against and/or within the handle 702, so that the user is able to place his/her hand around the handle 702 and the first tool 706 and the second tool 708. The user is then able to turn the handled ratcheting tool 700 in the same manner as a screwdriver.

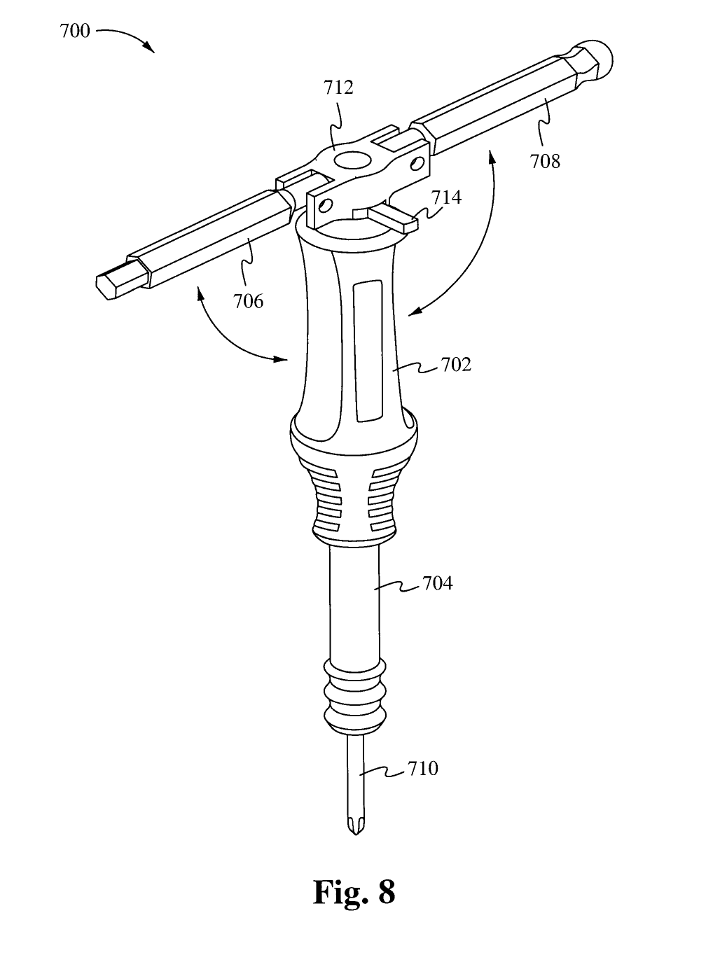

FIG. 8 illustrates a perspective view of a handled ratcheting tool 700 in a T-handle mode in accordance with an embodiment. As described above, the handled ratcheting tool 700 is put into the T-handle mode by rotating the first tool 706 and the second tool 708 to an open position where each tool is perpendicular to the handle 702.

The handled ratcheting tool is able to be composed of any material. In some embodiments, the tool is a combination of materials such as metal, plastic, polymers and rubber. The handled ratcheting tool is able to be any size.

The handled ratcheting tool is able to be used with any type of device such as bolts, screws, connections and other devices with any type of drive type such as various sized slotted screws, Phillips-head screws, hexagonal screws/bits, star screws/bits, pozidriv bits, torx bits, allen wrenches and screws, hex key bits, Robertson bits, tri-wing bits, Torx, torq-sets, spanner bits, drill bits, sockets of various shapes and sizes or the like.

In some embodiments, the handled ratcheting tool does not have a ratcheting mechanism and the tools are coupled to the handle.

In some embodiments, instead of two tools coupled to the ratcheting mechanism, three, four or more tools are coupled to the ratcheting mechanism.

In some embodiments, the tools are the same type but different sizes (e.g. ⅜″ hex, ¼″ hex, or others). In some embodiments, the tools are different types and the same size (e.g. hex, star, slotted). In some embodiments, the tools are different types and different sizes.

In some embodiments, the handled ratcheting tool is able to used in a modified-L or modified-T configuration, which is similar to the L or T configuration, but not approximately perpendicular. For example, the L configuration includes an approximately 90° angle between the tool and the handle, but a modified-L configuration includes a 75° angle between the tool and the handle.

In some embodiments, the arms are able to be locked in position in closed, partially open and fully open positions. In some embodiments, the arms are able to be locked in a fully open position but not in other positions. In some embodiments, the arms are able to be locked in any position.

In some embodiments, the first arm and the second arm are detachably coupled to the ratcheting mechanism or the handle.

To utilize the handled ratcheting tool, a user initially configures the handle in a desired orientation. The user is able to configure the handle into a standard, L handle or T handle configuration. Once in the desired orientation, the user is able to grasp the handle accordingly. The user uses the handle similarly to any other tool or ratchet tool for tightening or loosening screws, bolts or other items.

In operation, the handled ratcheting tool allows a user to reach items such as screws, bolts or other items that are not able to be reached by standard tools. For example, if a screw is tucked away in a partially enclosed area, the handle is able to be modified into an L handle orientation to allow the user to reach the item with the handle and perform the desired task. Furthermore, the handle is able to be configured in a T-handle orientation to provide a user with a better grip on the handle. The different configurations, standard, L handle and T handle enable one handle to be able to used for many different tasks and reduces the number of tools required by a user.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications can be made in the embodiment chosen for illustration without departing from the spirit and scope of the invention. Specifically, it will be apparent to one of ordinary skill in the art that the device and method of the present invention could be implemented in several different ways and have several different appearances.

1. A device comprising:
a. a handle element including a first end, a second end and a stem element at the first end;
b. a tool detachably coupled to the stem element;
c. a ratcheting element coupled to the second end of the handle element comprising a switch extending from the ratcheting element positioned adjacent the second end of the handle toggable between an un-lock position for toggling the ratcheting element in a ratcheting direction and a lock position for locking the ratcheting element in a non-ratcheting position; and
d. a plurality of arms coupled to the ratcheting element, the plurality of arms configurable in a screwdriver mode, a T-handle mode and an h-handle mode, wherein the arms are configured to be locked in position in closed, partially open and fully open positions.

2. The device of claim 1 wherein the plurality of arms are configured to be positioned against the handle element when configured in a closed position.

3. (canceled)

4. (canceled)

5. The device of claim 1 further comprising a hinge configured for coupling each of the plurality of arms to the ratcheting element.

6. The device of claim 1 wherein the screwdriver mode includes the plurality of arms positioned against the handle element in a closed position.

7. The device of claim 1 wherein the T-handle mode includes the plurality of arms positioned approximately perpendicular to the handle element in an open position.

8. The device of claim 1 wherein the L-handle mode includes one of the plurality of arms positioned approximately perpendicular to the handle element in an open position.

9. The device of claim 1 wherein the tool is configured to be utilized with a screw or a bolt.

10. The device of claim 9 wherein the screw or the bolt has a slotted, a Phillips, a hexagonal or a star head.

11. The device of claim 1 wherein the device comprises rubber, plastic, polymers, metal or a combination thereof.

12. A method of utilizing a device comprising:
a. providing a device comprising a handle element having a first end, a second end and a stem element at the first end and a ratcheting element coupled to the second end of the handle element comprising a switch extending from the ratcheting element positioned adjacent the second end of the handle toggable between an un-lock position for toggling the ratcheting element in a ratcheting direction and lock position for locking the ratcheting element in a non-ratcheting position;
b. configuring the device into any of a screwdriver mode, a T-handle mode and an L-handle mode; and
c. using the device in the configured mode.

13. The method of claim 12 wherein the device comprises:
a. a tool coupled to the stem element; and
b. a plurality of arms coupled to the ratcheting element, the plurality of arms configurable in the screwdriver mode, the T-handle mode and the L-handle mode.

14. The method of claim 13 wherein configuring the device into the screwdriver mode includes orienting the plurality of arms against the handle element.

15. The method of claim 13 wherein configuring the device into the T-handle mode includes orienting the plurality of arms to an open position approximately perpendicular to the handle element.

16. The method of claim 13 wherein configuring the device into the L-handle mode includes orienting one of the plurality of arms to an open position approximately perpendicular to the handle element.

17. The method of claim 13 wherein the plurality of arms are configured to be positioned against the handle element when configured in a closed position.

18. The method of claim 13 wherein the tool is detachably coupled to the stem element.

19. (canceled)

20. The method of claim 13 wherein the device further comprises a hinge for each of the plurality of arms, the hinge for coupling each of the plurality of arms to the ratcheting element.

21. The method of claim 13 wherein the tool and the plurality of arms are configured to be utilized with a screw or a bolt.

22. The method of claim 21 wherein the screw or the bolt has a slotted, a Phillips, a hexagonal or a star head.

23. The method of claim 13 wherein the device comprises rubber, plastic, polymers, metal or a combination thereof.

24. A method of manufacturing a device comprising:
a. forming a set of components including a handle element comprising a first end, a second end and a stem element, a ratcheting element coupled to the handle element comprising a switch extending from the ratcheting element toggable between an un-lock position for toggling the ratcheting element in a ratcheting direction and lock position for locking the ratcheting element in a non-ratcheting position, a first arm, a second arm and a tool; and
b. coupling the set of components including:
i. coupling the ratcheting mechanism to the second end of the handle element such that the switch is positioned adjacent the second end of the handle;
ii. coupling the stem element to the first end of the handle;
iii. coupling the first arm to the ratcheting mechanism;
iv. coupling the second arm to the ratcheting mechanism; and
v. coupling the tool to the stem element.

25. The method of claim 24 wherein the handle element is formed so the first and second arms are able to be positioned against the handle element.

26. The method of claim 24 wherein the tool is formed as screwdrivers, hex/allen wrenches, star wrenches or a combination thereof.

27. The method of claim 24 wherein the first arm and the second arm are coupled to the ratcheting mechanism at hinges to enable rotation between a closed position and an open position.

28. The method of claim 24 wherein the tool is detachably coupled to the stem element.

29. The method of claim 24 wherein the device is configurable in a screwdriver mode, a T-handle mode and an L-handle mode.

30. (canceled)

31. The method of claim 24 wherein the tool is configured to be utilized with a screw or a bolt.

32. The method of claim 31 wherein the screw or the bolt has a slotted, a Phillips, a hexagonal or a star head.

33. The method of claim 24 wherein the device comprises rubber, plastic, polymers, metal or a combination thereof.

34. A device comprising:
a. a handle element including a first end, a second end and a stem element at the first end;
b. a tool detachably coupled to the stem element;
c. a ratcheting element coupled to the second end of the handle element comprising a switch extending from the ratcheting element positioned adjacent the second end of the handle toggable between an un-lock position for toggling the ratcheting element in a ratcheting direction and a lock position for locking the ratcheting element in a non-ratcheting position; and
d. a plurality of arms coupled to the ratcheting element, each of the plurality of arms coupled at a hinge, the plurality of arms configurable in:
i. a screwdriver mode wherein the plurality of arms are positioned against the handle element in a closed position;
ii. a T-handle mode wherein the plurality of arms are positioned approximately perpendicular to the handle element in an open position; and
iii. an L-handle mode wherein one of the plurality of arms is positioned approximately perpendicular to the handle element in the open position.
